(19) United States
(12) Patent Application Publication
(10) Pub. No.: US 2016/0070867 A1
(43) Pub. Date: Mar. 10, 2016

(54) METHOD AND SYSTEM TO AUTOMATICALLY GENERATE MEANINGFUL STATEMENTS IN PLAIN NATURAL LANGUAGE FROM QUANTITATIVE PERSONALIZED CONTENT FOR PATIENT CENTRIC TOOLS

(71) Applicant: KONINKLIJKE PHILIPS N.V., Eindhoven (NL)

(72) Inventors: Jingyu Zhang, Briarcliff Manor, NY (US); Pavankumar Murli DADLANI MAHTANI, Eindhoven (NL); Marie Perez, Eindhoven (NL)

(21) Appl. No.: 14/783,093

(22) PCT Filed: Apr. 15, 2014
(86) PCT No.: PCT/IB2014/060723

§ 371 Date: Oct. 8, 2015

Related U.S. Application Data
(60) Provisional application No. 61/815,276, filed on Apr. 24, 2013.

(51) Int. Cl. G06F 19/00; G10L 13/027; G06F 17/28; G06F 17/30

(52) U.S. Cl. CPC G06F 19/324; G06F 17/30598; G06F 17/3053; G06F 19/3418; G06F 19/322; G10L 13/027; G06F 17/289

(57) ABSTRACT

A system (50) and method (100) translates quantitative personalized decision content to natural language. Quantitative personalized decision content for a patient is received. The quantitative personalized decision content includes quantitative outcomes of treatment options. Contributing factors for the quantitative outcomes are determined. The treatment options are ranked based on a quantitative measure of the quantitative outcomes. Natural language explanations are presented to the patient describing the most highly ranked treatment option in terms of the contributing factors.

The following relates generally to clinical and/or patient decision making. It finds particular application in conjunction with shared decision making and will be described with particular reference thereto. However, it is to be understood that it also finds application in other usage scenarios and is not necessarily limited to the aforementioned application.

Shared decision making is an approach where a clinician and a patient sit together and discuss different treatment options available to the patient, while taking into account the patient's preferences and the best available evidence, to jointly reach an informed decision. Shared decision making tools support patient reflection about the possible attributes and consequences of treatment options, and support patient consideration of personal preferences, to allow the patient to make an informed choice about the best course of action for the patient. In many controversial medical-decision-making situations, such as localized prostate cancer treatment decisions and localized breast cancer treatment decisions, shared decision making is strongly recommended by clinical guidelines.

Prostate cancer is the most common solid tumor in American men. One in six men will be detected with prostate cancer during their lifetime. Most of prostate cancer patients are detected when the cancer is still localized. However, there is no optimal treatment for localized prostate cancer for all patients. Rather, optimal treatment differs from patient to patient because it depends on the specific disease profiles and personal preferences of the patients. Breast cancer similarly poses a challenge. To support the determination of the optimal treatments for patients, there are systems to provide quantitative personalized decision content individually tailored to the patients. However, these systems typically only provide quantitative decision content in a manner suitable only for physicians to understand. Patients on the other hand typically have difficulty understanding the quantitative decision content.

The following provides new and improved methods and systems which overcome the above-referenced problems and others.

In accordance with one aspect, a system for translating quantitative personalized decision content to natural language is provided. The system includes at least one processor. The at least one processor is programmed to receive quantitative personalized decision content for a patient. The quantitative personalized decision content includes quantitative outcomes of treatment options. The at least one processor is further programmed to determine contributing factors for the quantitative outcomes, rank the treatment options based on a quantitative measure of the quantitative outcomes, and present natural language explanations to the patient describing the most highly ranked treatment option in terms of the contributing factors.

In accordance with another aspect, a method for translating quantitative personalized decision content to natural language is provided. Quantitative personalized decision content for a patient is received. The quantitative personalized decision content includes quantitative outcomes of treatment options. Contributing factors for the quantitative outcomes are determined. The treatment options are ranked based on a quantitative measure of the quantitative outcomes. Natural language explanations are presented to the patient describing the most highly ranked treatment option in terms of the contributing factors.

In accordance with another aspect, a system for translating quantitative personalized decision content to natural language is provided. The system includes a natural language translation module. The natural language translation module is configured to determine a common set of pros and cons for each of a plurality of treatment options described in the quantitative personalized decision content. The quantitative personalized decision content describes quantitative outcomes of the plurality of treatment options. The natural language translation module is further configured to present natural language explanations to the patient describing a selected set of the treatment options in terms of the common set of pros and cons in natural language and pictograms.

One advantage resides in the automatic generation of natural language explanations and quantitative personalized decision assistance tailored to the individual patient.

Another advantage resides in improved patient understanding of quantitative personalized decision content.

Another advantage resides in more informed patient decision making.

Still further advantages of the present invention will be appreciated to those of ordinary skill in the art upon reading and understand the following detailed description.

The invention may take form in various components and arrangements of components, and in various steps and arrangements of steps. The drawings are only for purposes of illustrating the preferred embodiments and are not to be construed as limiting the invention.

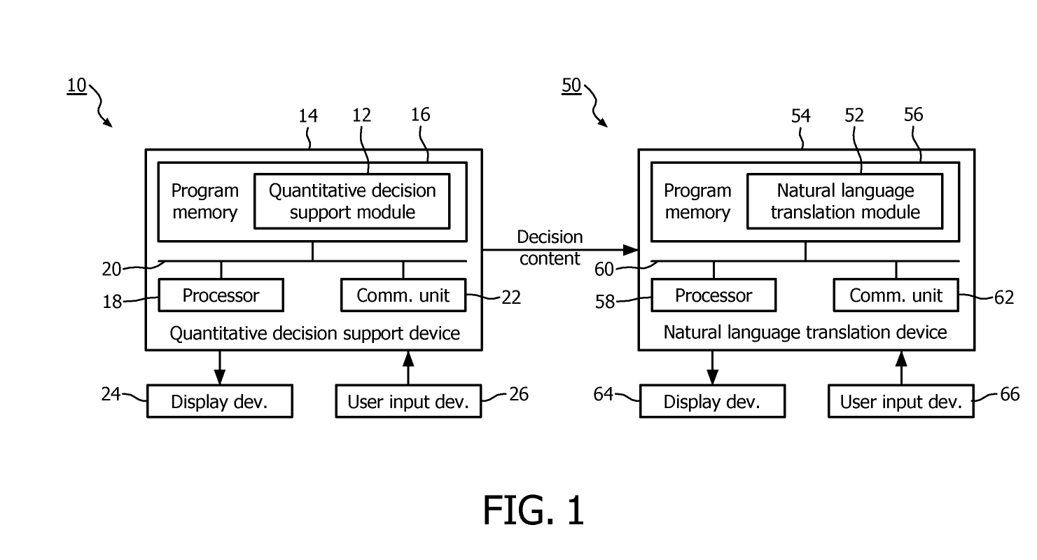

FIG. 1 illustrates a system generating natural language explanations of quantitative personalized decision content.

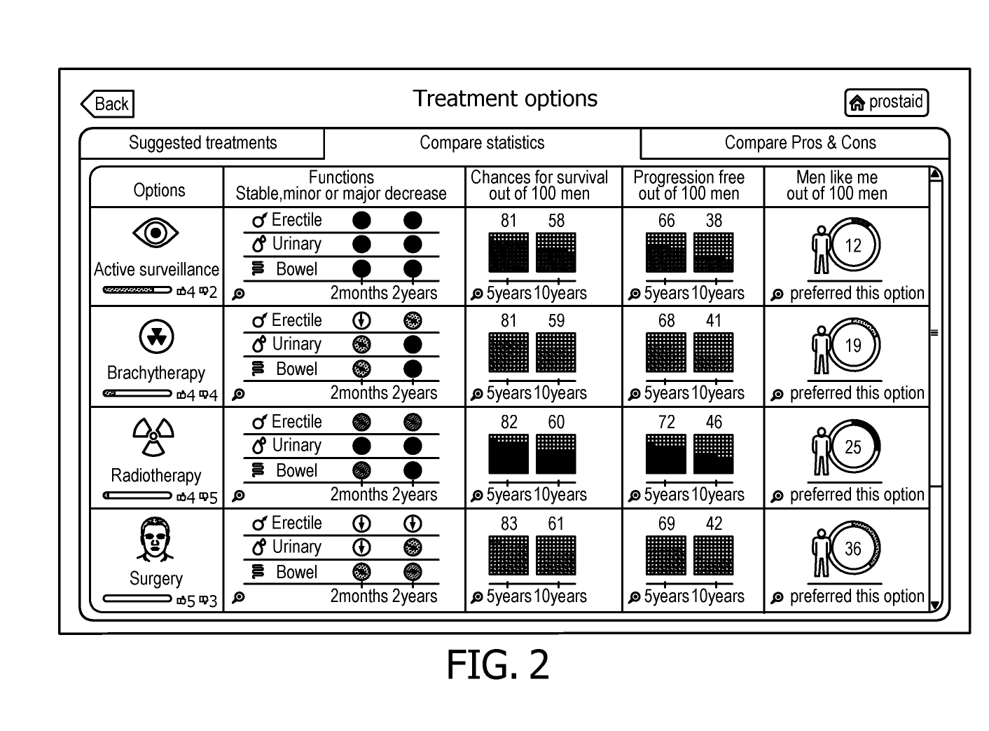

FIG. 2 illustrates an example display of quantitative personalized decision content.

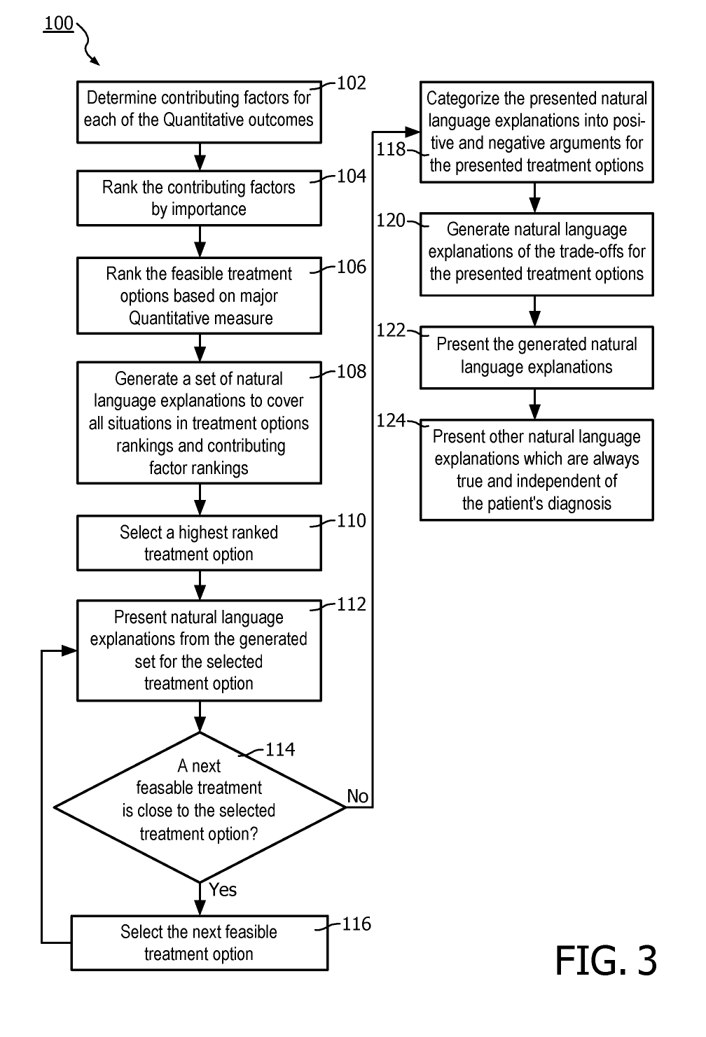

FIG. 3 illustrates a translation process for converting quantitative personalized decision content to natural language.

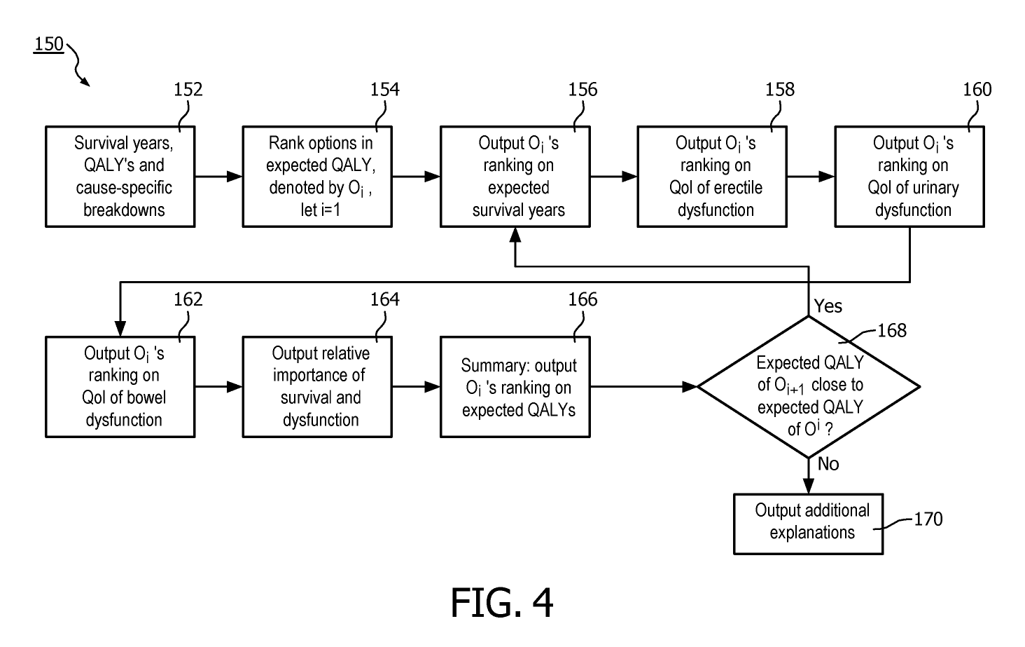

FIG. 4 illustrates an example of the translation process of FIG. 3 directed to prostate cancer.

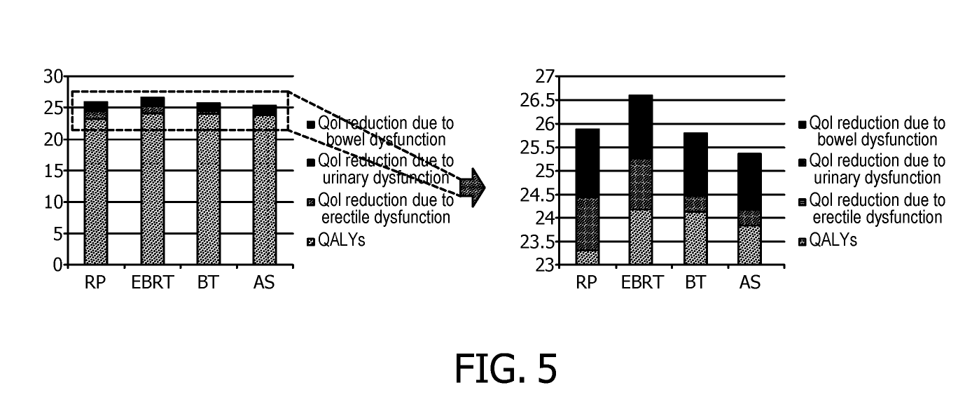

FIG. 5 illustrates a graphical representation of the breakdown of quantitative personalized decision content.

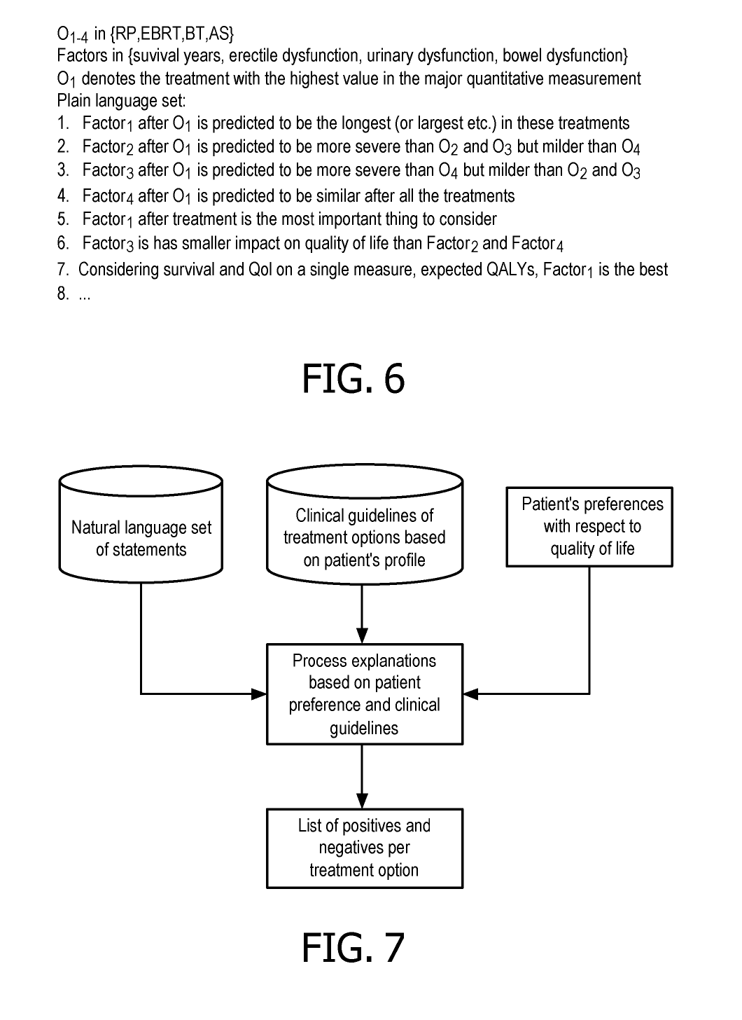

FIG. 6 illustrates an example of the generation of a set of natural language explanations.

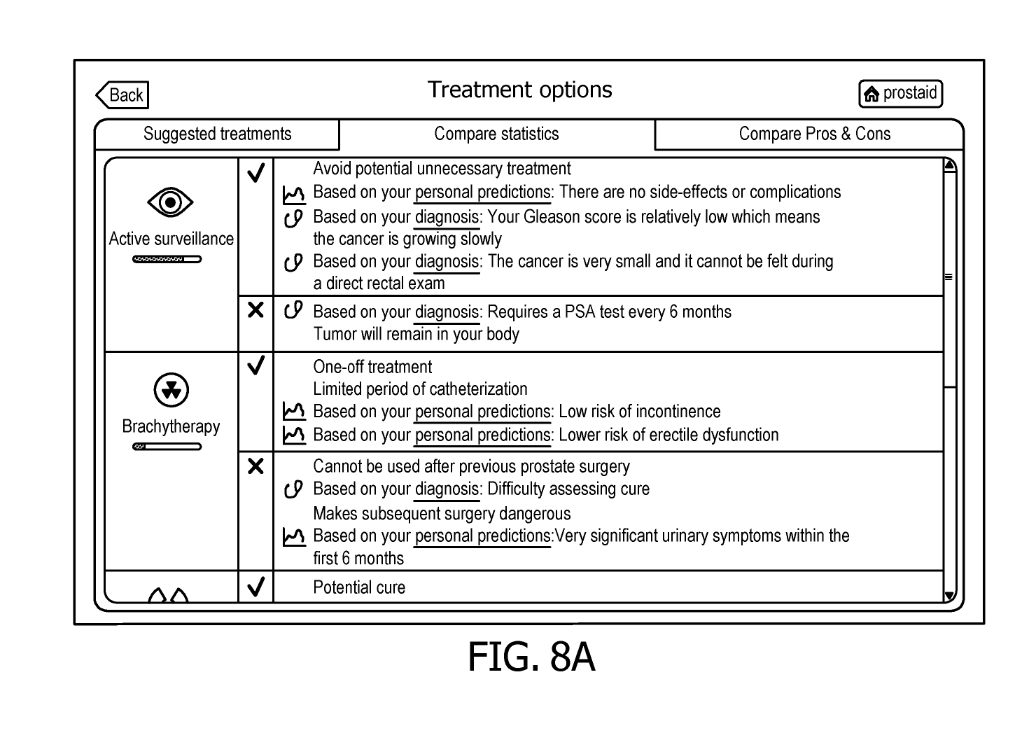

FIG. 7 illustrates the generation of trade-offs, as well as positive and negative arguments, towards the different treatment options.

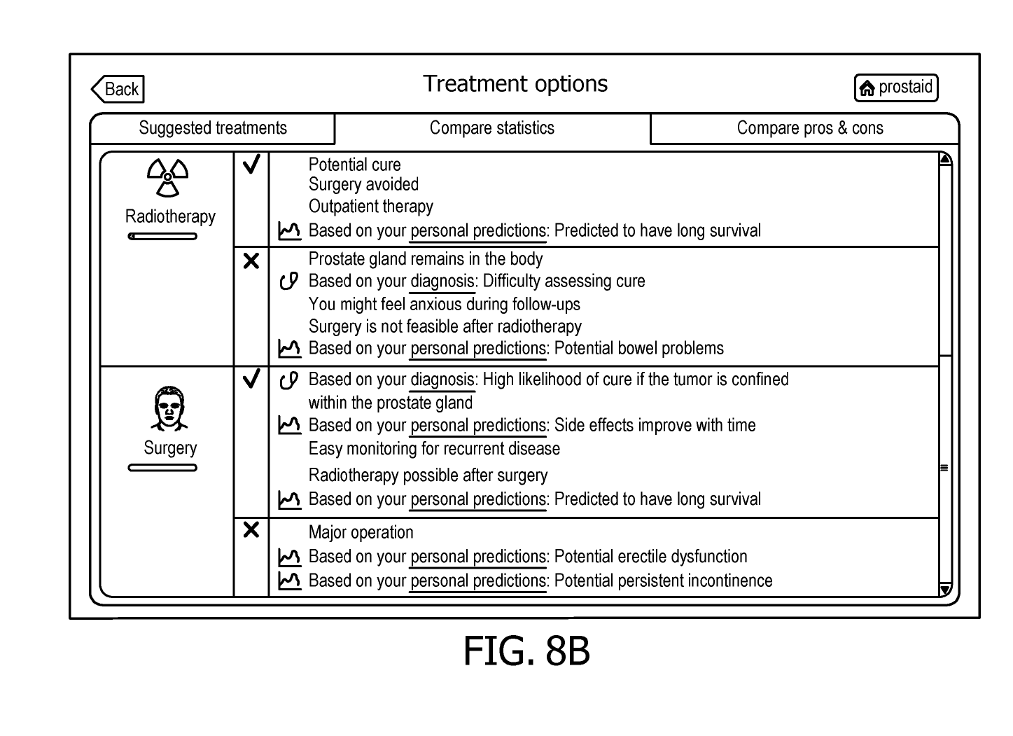

FIGS. 8A and 8B illustrates an example display of trade-offs, as well as positive and negative arguments, towards the different treatment options.

The present invention relates to a method and system which automatically generates plain language explanations of quantitative personalized decision content. The automatic plain language explanations are designed to deliver the same message as the quantitative personalized decision content without involving a lot of numbers, probabilities, and other content difficult for patients to understand under the stress of being diagnosed with cancer.

According to one embodiment, quantitative personalized decision content is broken down into different factors contributing to quantitative outcomes of different treatment options. These contributing factors are ranked based on importance and a set of plain language explanations to exhaustively cover all the situations in treatment option and factor rankings is prepared. Feasible treatment options are ranked according to the major quantitative measure of the quantitative outcomes, and the highest ranked options are selected for detailed explanation to the patient. Plain language statements are presented to the patients from the prepared set of plain language explanations to describe how the selected treatment options rank among certain contributing factors according to the order of importance of these contributing factors. Other outputs, such as the relative importance of these contributing factors, are also presented to the patients in plain language from the prepared set of plain language explanations. Further, personalized decision content is summarized and presented to the patients on the major quantitative measures using explanations from the set of plain language explanations.

With reference to FIG. 1, a quantitative decision support system 10 generates quantitative personalized decision content to support the determination of optimal treatments for patients. The quantitative personalized decision content is patient specific and generated based on one or more of patient preferences, patient medical records, patient vital sign measurements, and the like. Patient preferences can be received from a user of the quantitative decision support system 10 and determined by a patient survey or questionnaire including, for example, questions on current state of urinary and bowel functions, life style, patient weighting of lifestyle choices, etc. Further, the quantitative personalized decision content is generated to be used and understood by medical professionals, such as doctors and nurses, and patients with advanced relevant knowledge, not ordinary patients. Hence, the quantitative personalized decision content is difficult for the average patient to understand. The quantitative personalized decision content includes quantitative outcomes of treatment options and is described in terms of, for example, statistics, vital sign measurements, charts, technical terms, and the like.

With reference to FIG. 2, an example display of quantitative personalized decision content is illustrated. The displayed treatment options include active surveillance (AS), brachytherapy (BT), external beam radiotherapy (EBRT), and surgery. Each treatment option includes a bar under the label for the respective treatment option indicating the likelihood that the treatment option is the best. Further, each treatment option includes indicates the extent of dysfunction (e.g., stable, minor or major) with bodily functions, such as erectile, urinary and bowel functions, for one or more time points after the treatment option, such as 2 months and 2 years after the treatment option. Even more, each treatment option indicates the survival rate and the progression-free rate for one or more time points after the treatment option, such as 5 and 10 year, and the number of like patients that chose the treatment option historically.

To generate the quantitative personalized decision content, the quantitative decision support system 10 includes a quantitative decision support module 12. The quantitative decision support module 12 is comprised of processor executable instructions for generating quantitative personalized decision content. The quantitative decision support module 12 is distributed across one or more quantitative decision support devices 14, such as computers. Each of the quantitative decision support devices 14 includes at least one program memory 16 and at least one processor 18, the at least one program memory 16 including the processor executable instructions of the corresponding portion of the quantitative decision support module 12 and the at least one processor 18 executing the processor executable instructions of the corresponding portion of the quantitative decision support module 12.

Each of the quantitative decision support devices 14 further includes at least one system bus 20 and at least one communication unit 22. The at least one system bus 20 interconnects the at least one processor 18, the at least one program memory 16, and the at least one communication unit 22, of the corresponding quantitative decision support device 14 to allow communication between these components. The at least one communication unit 22 provides the at least one processor 18 of the corresponding quantitative decision support device 14 an interface for communicating with external systems and/or devices. For example, where the quantitative decision support system 10 includes a plurality of quantitative decision support devices 14, the plurality of quantitative decision support devices 14 can communicate using corresponding communication units 22.

The quantitative decision support devices 14 is further in communication with a display device 24 and a user input device 26. The display device 24 allows the quantitative decision support devices 14 to output, present, or display data to a user of the quantitative decision support devices 14. The user input device 26 allows the quantitative decision support devices 14 to receive input from a user of the natural language translation system 50, such as survey data.

A natural language translation system 50 receives quantitative personalized decision content from the quantitative decision support system 10 and translates the quantitative personalized decision content into plane language explanations to be used and understood by patients. The translations are patient specific and generated based on one or more of patient preferences, patient medical records, patient vital sign measurements, and the like. Advantageously, the translations improve patient understanding of quantitative personalized decision content and allow patients to make better informed choices about their treatment.

To generate the translations, the natural language translation system 50 includes a natural language translation module 52. The natural language translation module 52 is comprised of processor executable instructions for translating quantitative personalized decision content into natural language according to a translation process 100 (FIG. 3). Suitably, natural language excludes probabilities, technical terms, and the like.

With reference to FIG. 3, according to the translation process 100, the quantitative personalized decision content for a patient is broken into different factors contributing to the quantitative outcomes of the quantitative personalized decision content by determining 102 the contributing factors for each of the quantitative outcomes. Quantitative outcomes are typically in terms of quality adjusted life years (QALYs), but can be in terms of other metrics (e.g., survival years). The contributing factors are quantitative and in terms of the same metric as the quantitative outcomes, such as QALYs. The contributing factors include, for example, survival, quality of life reduction due to complications, side effects, and the like. The quantitative outcomes and the contributing factors are tailored to the specific disease for which the patient seeks treatment.

The contributing factors are ranked 104 by importance to the corresponding quantitative outcomes, and the feasible treatment options are ranked 106 based on the major quantitative measurement. A feasible treatment option can, for example, be user defined, defined as a treatment option with QALYs exceeding a predetermined threshold, or defined in any other way. The major quantitative measurement is the quantitative metric of the quantitative outcomes, typically QALYs. Further, a set of natural language explanations to exhaustively cover all the situations in treatment option rankings and contributing factor rankings are generated 108. A medical professional suitably generates the natural language explanations.

The highest ranked treatment option is selected 110. Natural language explanations from the generated set describing the selected treatment option are presented 112 to the patient. For example, a natural language explanation can be presented to describe how the selected treatment option ranks among the other treatment options. As another example, natural language explanations can be presented to describe a predetermined number of the most highly ranked contributing factors for the selected treatment option in order of importance and, in some instances, to describe the relative importance of the presented contributing factors. A user of the natural language translation system 50 can set the predetermined number. As another example, a natural language explanation can be presented to describe the quantitative personalized decision content based on the major quantitative measure.

A determination is made 114 as to whether the next feasible treatment option is close to the currently selected treatment option in terms of the major quantitative measure. Two treatment options are close if the difference between the major quantitative measures is less than a predetermined threshold set by a user of the natural language translation system 50. In response to determining the next feasible treatment option is close to the currently selected treatment option, the next feasible treatment option is selected 116 and natural language explanations from the generated set describing the newly selected treatment option are presented to the patient as described above. This repeats until there are no longer further feasible treatment options that are close.

In some instances, in response to determining the next feasible treatment option is not close to the currently selected treatment option, each natural language explanation presented to the patient is categorized 118 into a positive or negative argument towards different treatment options. The categorizing is based on two aspects: clinical guidelines and quality of life (QoL) preferences by the patient. QoL preferences of the patient are typically determined by surveying the patient, but other approaches are contemplated. Based on the categorization, natural language explanations of trade-offs for each presented treatment option are generated 120 based on, and typically in terms of, the contributing factors. These natural language explanations are presented 122 to the patient.

Further, in some instances, other natural language explanations, which are independent of the patient's diagnosis and always true, are presented 124 to the patient for the presented treatment options. A user of the natural language translation system 50 can generate these natural language explanations.

Referring back to FIG. 1, similar to the quantitative decision support module 12, the natural language translation module 52 is distributed across one or more natural language translation devices 54, such as computers. Each of the natural language translation devices 54 includes at least one program memory 56 and at least one processor 58, the at least one program memory 56 including the processor executable instructions of the corresponding portion of the natural language translation module 52 and the at least one processor 58 executing the processor executable instructions of the corresponding portion of the natural language translation module 52.

Each of the natural language translation devices 54 further includes at least one system bus 60 and at least one communication unit 62. The at least one system bus 60 interconnects the at least one processor 58, the at least one program memory 56, and the at least one communication unit 62, of the corresponding natural language translation device 54 to allow communication between these components. The at least one communication unit 62 provides the at least one processor 58 of the corresponding natural language translation device 54 an interface for communicating with external systems and/or devices. For example, where the natural language translation system 50 includes a plurality of natural language translation devices 54, the plurality of natural language translation devices 54 can communicate using corresponding communication units 52.

The natural language translation system 50 is further in communication with a display device 64 and a user input device 66. The display device 64 allows the natural language translation system 50 to output, present, or display data to a user of the natural language translation system 50. Typically, this data is natural language explanations. The user input device 66 allows the natural language translation system 50 to receive input from a user of the natural language translation system 50.

Although the quantitative decision support system 10 is shown independent of the natural language translation system 50, the two systems can be combined. For example, the quantitative decision support module 12 and the natural language translation module 52 can be integrated into a common system.

To illustrate the translation process 100 described above, attention is directed to FIG. 4 describing an example 150 of the translation process 100 directed to prostate cancer. The quantitative personalized decision content for a patient is broken into different factors contributing to the quantitative outcomes of the quantitative personalized decision content by determining 152 the contributing factors for each of the quantitative outcomes. The quantitative outcomes are in terms of expected QALYs. The treatment options can include radical prostatectomy (RP), AS, BT, and EBRT. The contributing factors include expected survival years and predicted erectile, urinary, and bowel dysfunctions.

With reference to FIG. 5, a graphical representation of the breakdown of quantitative personalized decision content is illustrated. The ordinate represents years, and the abscissa represents treatment options. The illustrated treatment options include RP, EBRT, BT and AS. The bars for each treatment option are broken down into QoL reduction due to bowel dysfunction, QoL reduction due to urinary dysfunction, QoL reduction due to erectile dysfunction and expected QALYs. The summation of these components for a treatment option equals survival years for the treatment option. As noted above, the expected QALYs represent the major quantitative measure of the quantitative outcomes.

Referring back to FIG. 4, the contributing factors are ranked by importance in terms of years. According to the graphical representation of FIG. 5, the ranking is survival years, erectile dysfunction, urinary dysfunction, and bowel dysfunction from most important to least important. Further, a set of natural language explanations are generated to exhaustively cover all the situations in treatment option rankings and contributing factor rankings, as illustrated in FIG. 6. In addition to ranking the contributing factors, the treatment options (i.e., RP, EBRT, BT and AS) are ranked 154 according to expected QALYs (i.e., the major quantitative measurement). According to the graphical representation of FIG. 5, the ranking is EBRT, BT, AS and RP from highest expected QALYs to lowest expected QALYs. Within FIG. 4, i is the index in the ranked list of treatment options and i=1 is the index of the most highly ranked treatment option.

The highest ranked treatment option is selected. Natural language explanations from the generated set are presented to describe how this selected treatment option ranks in all these contributing factors according to the order of importance of the contributing factors, such as survival years, erectile, urinary, and bowel dysfunctions. As illustrated, a natural language explanation for expected survival years is presented 156, such as “Survival after EBRT is predicted to be the longest in these 4 treatments”. Further, natural language explanations for QoL of erectile, urinary and bowel dysfunctions are presented 158, 160, 162. Examples of these explanations include “Erectile dysfunction after EBRT is predicted to be more severe than AS and BT but milder than RP”, “Urinary dysfunction after EBRT is predicted to be more severe than AS but milder than BR and RP”, and “Bowel dysfunction is predicted to be similar after all four treatments”.

In addition to the foregoing natural language explanations, the relative importance of the contributing factors are presented 164 in plain language from the generated set, and the quantitative personalized decision content is summarized 166 based on the expected QALYs using the corresponding natural language explanations from the generated set. An example of the former is “Survival years after treatment is the most important thing to consider; urinary dysfunction has a smaller impact on quality of life than erectile and bowel dysfunctions”. An example of the latter is “Considering survival and QoL on a single measurement, expected QALYs, EBRT is the best”.

After presenting natural language explanations for the selected treatment option, a determination is made 168 as to whether the next feasible treatment option is close to the selected treatment option in terms of expected QALYs. As noted above, close means that the difference between the expected QALYs of the selected treatment option and the next feasible treatment option is less than a predetermined threshold set by a user of the natural language translation system 50. In response to determining the next feasible treatment option is close to the currently selected treatment option, the next feasible treatment option is selected and natural language explanations from the generated set describing the newly selected treatment option are presented to the patient as described above. This repeats until there are no longer further feasible treatment options that are close.

In response to determining the next feasible treatment option is not close to the currently selected treatment option, additional natural language explanations can be presented 170. This can include categorizing each natural language explanation presented to the patient into a positive or negative argument towards different treatment options. The categorizing is based on two aspects: clinical guidelines and QoL preferences by the patient. Based on the categorization, natural language explanations of trade-offs for each presented treatment option are generated based on, and typically in terms of, the contributing factors. These natural language explanations are presented to the patient. FIG. 7 illustrates the generation of trade-offs, as well as positive and negative arguments, towards the different treatment options.

With reference to FIGS. 8A and 8B, an example display of trade-offs, as well as positive and negative arguments, towards the different treatment options is illustrated. The displayed treatment options include AS, surgery and BT. Each treatment option includes a bar under the label for the respective treatment option indicating the likelihood that the treatment option is the best. Further, each treatment option includes natural language explanations of the positives and negatives of the treatment option, as well as a check mark (e.g., in green) and/or an “X” (e.g., in red) indicating which of the explanations are positive and/or negative, respectively.

Further, in some instances, the additional natural language explanations can include other natural language explanations, which are independent of the patient's diagnosis and always true. These natural language explanations are presented to the patient for the presented treatment options. A user of the natural language translation system can generate these natural language explanations.

Although described in connection with prostate cancer, it is to be appreciated that the translation process 100 herein can be applied to other diseases and conditions, such as breast cancer. As to breast cancer, the treatment options under consideration can include surgery, biological therapy, hormone therapy, and chemotherapy. Further, the major quantitative measure can be expected QALYs and the contributing factors can be aesthetics (e.g., remove entire breast or part, and hair loss), energy level (e.g., tiredness), frequency of visiting hospital (e.g., impact on daily routine) and life expectancy. As should be appreciated, these contributing factors can be applied for prostate cancer as well.

Further, although the translation process 100 described above intelligently interprets quantitative personalized decision content, it can also more simply convert the quantitative personalized decision content to natural language. For examples, charts or technical terms in the quantitative personalized decision content can be described in natural language.

As used herein, a memory includes one or more of a non-transient computer readable medium; a magnetic disk or other magnetic storage medium; an optical disk or other optical storage medium; a random access memory (RAM), read-only memory (ROM), or other electronic memory device or chip or set of operatively interconnected chips; an Internet/Intranet server from which the stored instructions may be retrieved via the Internet/Intranet or a local area network; or so forth. Further, as used herein, a processor includes one or more of a microprocessor, a microcontroller, a graphic processing unit (GPU), an application-specific integrated circuit (ASIC), a field-programmable gate array (FPGA), and the like; a controller includes: 1) at least one memory with processor executable instructions to perform the functionality of the controller; and 2) at least one processor executing the processor executable instructions; a user output device includes a printer, a display device, and the like; and a display device includes one or more of a liquid crystal display (LCD), an light-emitting diode (LED) display, a plasma display, a projection display, a touch screen display, and the like.

The invention has been described with reference to the preferred embodiments. Modifications and alterations may occur to others upon reading and understanding the preceding detailed description. It is intended that the invention be construed as including all such modifications and alterations insofar as they come within the scope of the appended claims or the equivalents thereof.

1. A system for translating quantitative personalized decision content to natural language, said system comprising:
at least one processor programmed to:
receive quantitative personalized decision content for a patient, the quantitative personalized decision content including quantitative outcomes of treatment options;
determine contributing factors for the quantitative outcomes;
rank the treatment options based on a quantitative measure of the quantitative outcomes; and
present natural language explanations to the patient describing the most highly ranked treatment option in terms of the contributing factors.

2. The system according to claim 1, wherein the at least one processor is further programmed to:
select the most highly ranked treatment option; and
until the difference between the quantitative outcome of the selected treatment option and the quantitative outcome of the next most highly ranked treatment option in terms of the quantitative measure exceeds a threshold, repeatedly:
select the next most highly ranked treatment option; and
present natural language explanations to the patient describing the contributing factors of the selected treatment option.

3. The system according to claim 2, wherein the at least one processor is further programmed to:
categorize the presented natural language explanations into positive and negative arguments towards the treatment options;
based on the categorization, generate natural language explanations describing tradeoffs for the treatment options for which natural language explanations were presented; and
present the natural language explanations describing tradeoffs to the patient.

4. The system according to claim 3, wherein the at least one processor is further programmed to:
for each of the presented treatment options:
present the natural language explanations describing tradeoffs for the presented treatment option clustered into positives and negatives; and
adjacent the natural language explanations describing tradeoffs for the presented treatment option, present the quantitative outcome of the presented treatment option.

5. The system according to claim 1, wherein the at least one processor is further programmed to:
present the treatment options of the quantitative personalized decision content by:
presenting bars or the like indicating the likelihoods of the treatment options being the best;
presenting bars or the like indicating the durations of bowel, urinary and erectile dysfunctions; and
presenting charts or the like indicating survival rate and recurrence rate over time.

6. (canceled)

7. The system according to claim 1, wherein the quantitative personalized decision content is generated for the understanding of skilled medical professionals, and patients with advanced relevant knowledge, but not ordinary patients, and wherein the natural language explanations are generated for the understanding of patients.

8. The system according to claim 1, wherein the at least one processor is further programmed to:
rank the contributing factors based on contribution to the quantitative outcomes; and
present natural language explanations to the patient describing how the most highly ranked treatment option ranks in the contributing factors.

9. The system according to claim 1, wherein the at least one processor is further programmed to:
present natural language explanations to the patient describing the contributions of the contributing factors to the quantitative outcome of the most highly ranked treatment option.

10. The system according to claim 1, wherein the quantitative personalized decision content is generated for the treatment of prostate cancer;
wherein the contributing factors include survival years and quality of life (QoL) reduction due to bowel dysfunction, QoL reduction due to urinary dysfunction and QoL reduction due to erectile dysfunction; and
wherein the treatment options include active surveillance (AS), brachytherapy (BT), external beam radiotherapy (EBRT), and radical prostatectomy (RP).

11. A method for translating quantitative personalized decision content to natural language, said method comprising:
receiving quantitative personalized decision content for a patient, the quantitative personalized decision content including quantitative outcomes of treatment options;
determining contributing factors for the quantitative outcomes;
ranking the treatment options based on a quantitative measure of the quantitative outcomes; and
presenting natural language explanations to the patient describing the most highly ranked treatment option in terms of the contributing factors.

12. The method according to claim 11, further including:
selecting the most highly ranked treatment option; and
until the difference between the quantitative outcome of the selected treatment option and the quantitative outcome of the next most highly ranked treatment option in terms of the quantitative measure exceeds a threshold, repeatedly:
selecting the next most highly ranked treatment option; and
presenting natural language explanations to the patient describing the selected treatment option in terms of the contributing factors.

13. The method according to claim 12, further including:
categorizing the presented natural language explanations into positive and negative arguments towards the treatment options;
based on the categorization, generate natural language explanations describing tradeoffs for the treatment options for which natural language explanations were presented; and
present the natural language explanations describing tradeoffs to the patient.

14. (canceled)

15. The method according to claim 1, further including:
ranking the contributing factors based on contribution to the quantitative outcomes; and
presenting natural language explanations to the patient describing how the most highly ranked treatment option ranks in the contributing factors.

16. The method according to claim 1, further including:
presenting natural language explanations to the patient describing the contributions of the contributing factors to the quantitative outcome of the most highly ranked treatment option.

17. (canceled)

18. (canceled)

19. A non-transitory computer readable medium carrying software which contains one or more processors to perform the method according to claim 11.

20. (canceled)
